(19) United States
(12) Patent Application Publication
(10) Pub. No.: US 2020/0013045 A1
(43) Pub. Date: Jan. 9, 2020

(54) STAKE POOL FOR A SECURE AND TRUSTED DATA COMMUNICATION SYSTEM

(71) Applicant: Flexa Network Inc., New York, NY (US)

(72) Inventors: Tyler Robert Spalding, New York, NY (US); Zachary Kilgore, New York, NY (US); Trevor Filter, New York, NY (US)

(73) Assignee: Flexa Network Inc., New York, NY (US)

(21) Appl. No.: 16/503,341

(22) Filed: Jul. 3, 2019

Related U.S. Application Data
(60) Provisional application No. 62/694,831, filed on Jul. 6, 2018.

(51) Int. Cl. G06Q 20/36; H04L 29/06; H04W 12/00

(52) U.S. Cl. CPC G06Q 20/3674; G06Q 2220/00; H04W 12/0013; H04L 63/04

(57) ABSTRACT

A method includes receiving a request from a computing device requesting that a digital wallet rendered by a digital wallet application executed on the computing device be recognized and accepted within a secure and trusted data communication system for purposes of financial transactions using a first cryptocurrency. The method further includes verifying that the first cryptocurrency is a valid form of cryptocurrency in accordance with a validation protocol. When the first cryptocurrency is valid, the method further includes establishing a per unit value of the first cryptocurrency based on a per unit value of a known and trusted cryptocurrency of the system, obtaining a set of units of collateral cryptocurrency for a plurality of units of first cryptocurrency based on the established per unit value of the first cryptocurrency, and storing the set of units of collateral cryptocurrency in a secure stake pool for transactions utilizing the first cryptocurrency.

### CROSS-REFERENCE TO RELATED APPLICATIONS

The present U.S. Utility Patent Application claims priority pursuant to 35 U.S.C. § 119(e) to U.S. Provisional Application No. 62/694,831, entitled “CRYPTOCURRENCY ACCEPTANCE PLATFORM AND METHOD,” filed Jul. 6, 2018, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to data communication systems and more particularly to secure and trusted cryptocurrency transactions.

### Description of Related Art

Secure data communication involves transfer of data over a channel in a secure manner, which typically involves data encryption. For example, public key infrastructure (PKI) is an encryption method and cybersecurity protocol that secures communications between a server and a client by using two different cryptographic keys (e.g., a public key and a private key); the public key to encrypt and the private key to decrypt. PKI is frequently used for sending large files between organizations and for exchanging secure emails. As long as the private key is only possessed by authorized users, then the authorized users are only ones that can decrypt the data. Thus, no matter who receives the encrypted data, without the private key, it is extremely difficult to recover the data.

Security protocols such as Transmission Control Protocol (TCP), Internet Protocol (IP), Hyper Text Transfer Protocol Secure (HTTPS), Post Office Protocol 3 (POP3), and Internet Message Access Protocol (IMAP) are communication protocols that establish secure communications between computing devices and involve encryption. For instance, TCP is used by two commuting devices to exchange data therebetween. The TCP protocol guarantees delivery of data between the computing devices and also guarantees that packets will be delivered in the same order in which they were sent.

Hardware and software implemented secure transmission protocols are used by many infrastructures (e.g., banks) to detect and prevent unauthorized data access. For example, data loss prevention software uses deep content analysis and central policies to identify, monitor, and protect data within a system. As another example, anti-virus or anti-malware software disarms and removes malicious software from computing devices.

Cloud computing solutions allow for secure online file sharing. For example, one online cloud storage system uses 256-bit Advanced Encryption Standard (AES) for files at rest and Secure Sockets Layer (SSL)/Transport Layer Security (TLS) to protect data in transit between user device apps and the servers. SSL/TLS creates a secure tunnel protected by 128-bit or higher Advanced Encryption Standard (AES) encryption and user device applications and infrastructures are regularly tested for security vulnerabilities. The system also requires a login authentication and public files are only viewable by those who have a link to the files. Extensions of such applications allow for authenticated digital signatures and secure management and storage of important files requiring agreement (e.g., contracts).

Close proximity file sharing applications using Bluetooth allow for secure file sharing by creating a peer-to-peer Wi-Fi network between in-range devices where each device creates a firewall around the connection and encrypted files are exchanged. However, detecting in-range devices via a Wi-Fi connection can present some security issues. For instance, if detecting all in range devices, any devices within range can request to send a file and/or attempt to install malware on the initiating device. Further, if the file sharing application is always enabled, the initiating device may inadvertently share data.

The ease of online data exchange presents copyright infringement and internet piracy concerns. For example, copied or illegally downloaded material can be shared via many different platforms (e.g., peer-to-peer file sharing, email, etc.). To combat piracy, cloud based streaming services negotiate licensing to provide content and enforce access control to avoid copyright infringement. For example, data is kept in “the cloud” and is accessed via an internet connection and a subscription. Such services have reduced piracy by providing free and legal content to consumers. However, stream ripping software can allow any user to turn a file being played on any streaming platform into a file that can be saved and duplicated.

Another data exchange security issue is fraud and identity theft. Fraud and identify theft are particularly concerning in financial applications. One issue is that a typical payment card transaction with a merchant involves several steps (e.g., card authorization, clearing, and settlement) and the participation of various entities. Each step and each entity has its own varying security problems.

The steps involved are also inconvenient, time consuming, and result in additional fees. For example, card authorization (e.g., credit or debit card authorization) begins with the cardholder presenting the card to a merchant for goods or service. The merchant uses a credit card machine, software, or gateway to transmit transaction data to their acquiring bank (or its processor). The acquiring bank routes the transaction data to a card-processing network and the card-processing network sends the transaction data to the cardholder's issuing bank. The issuing bank validates that the card has not been reported stolen or lost, confirms whether funds are available, and sends a response code back through the card-processing network to the acquiring bank as to whether the transaction is approved.

The transaction data typically includes the card number, transaction amount, date, merchant's name, merchant's location, merchant category code, and an encrypted personal identification number (PIN) if entered. The response code reaches the merchant's terminal and is stored in a file until it is settled. The merchant sends the stored, approved transactions to its acquiring back (e.g., at the end of the day) and the acquiring bank reconciles and transmits approved transactions through the appropriate card-processing network. The acquiring bank deposits funds from sales into the merchant's account. The card-processing network debits the issuing bank account and credits the acquiring bank account for the amount of the transaction.

Mobile wallet applications allow cardholders to store card data on a computing device via a digital wallet for convenient transactions. For example, some mobile wallet apps use near field communication (NFC) for contactless payments (e.g., exchange of data by holding device over a payment reader). NFC chips are specifically designed to manage financial security and only store data needed to initiate and complete a transaction. Mobile wallets use types of tokenization to assign a device account number (DAN) in place of an account or card number so that the DAN is passed to the merchant rather than the actual account/card number. As another security measure, digital wallets rely on digital certificates to verify identity. However, using a digital wallet on a device means data passes through not only the device's hardware and operating system but then also a specific payment app, and then finally the source of payment. Further, user fraud (e.g., double spending, etc.) via mobile wallets is possible.

Thus, digital payment instruments consist of complicated financial settlement processes where merchants have to pay processing fees for purchases and involve several different entities (each a discrete point of failure) to process a single exchange. Meanwhile, fraud losses continue to reach all-time highs. Hackers are able to crack merchant systems and other card data holders to access large volumes of card data. Further, fraud such as the use of fake or stolen credit cards and gift cards remains prevalent.

Blockchain technology reduces the risk of fraudulent activity and has a wide range of applications (e.g., secure payment, record keeping, payment systems, management, monitoring, etc.). A blockchain is an immutable ledger for recording transactions within a network, consisting of a continuously growing list of blocks (i.e., groups of transactions) that are securely linked, continually reconciled, and shared among all network participants. Transactions are validated and added to blocks via hashing algorithms, and then permanently written to the chain via consensus of the entire network. Once recorded on the blockchain, transactions cannot be altered.

The first distributed blockchain was conceptualized in 2008 and implemented as a core component of a worldwide cryptocurrency and digital payment system in 2009 where it serves as the public transaction ledger. The digital payment system is designed to transmit cryptocurrency via pseudo-anonymous transactions that are open and public (i.e., anyone can join and view any transaction that has ever happened on the network). To minimize fraudulent activity and deter malicious network activity, the digital payment system implements “proof of work” secure hashing algorithms (SHA-256) that require significant computing power. Since the release of the initial cryptocurrency Bitcoin, over 4,000 alternative variations of cryptocurrencies have been created.

### BRIEF DESCRIPTION OF THE SEVERAL VIEWS OF THE DRAWING(S)

FIG. 1 is a schematic block diagram of an embodiment of a secure & trusted data communication system in accordance with the present invention;

FIG. 2 is a schematic block diagram of another embodiment of the secure & trusted data communication system in accordance with the present invention;

FIG. 3 is a schematic block diagram of another embodiment of the secure & trusted data communication system in accordance with the present invention;

FIG. 4 is a schematic block diagram of an example of a secure stake pool in accordance with the present invention;

FIG. 5 is a schematic block diagram of an embodiment of user computing device account setup with secure data conveyance device in accordance with the present invention;

FIG. 6 is a schematic block diagram of a user computing device account setup with secure data conveyance device blockchain in accordance with the present invention;

FIGS. 7A-7B are flowcharts of an example of a method of conveying cryptocurrency in accordance with the present invention;

FIGS. 8A-8B are flowcharts of another example of a method of conveying cryptocurrency in accordance with the present invention;

FIG. 9 is a flowchart of an example of a method of ending a conveyance by secure data conveyance device in accordance with the present invention; and

FIG. 10 is a flowchart of an example of a method of a secure stake pool in accordance with the present invention.

### DETAILED DESCRIPTION OF THE INVENTION

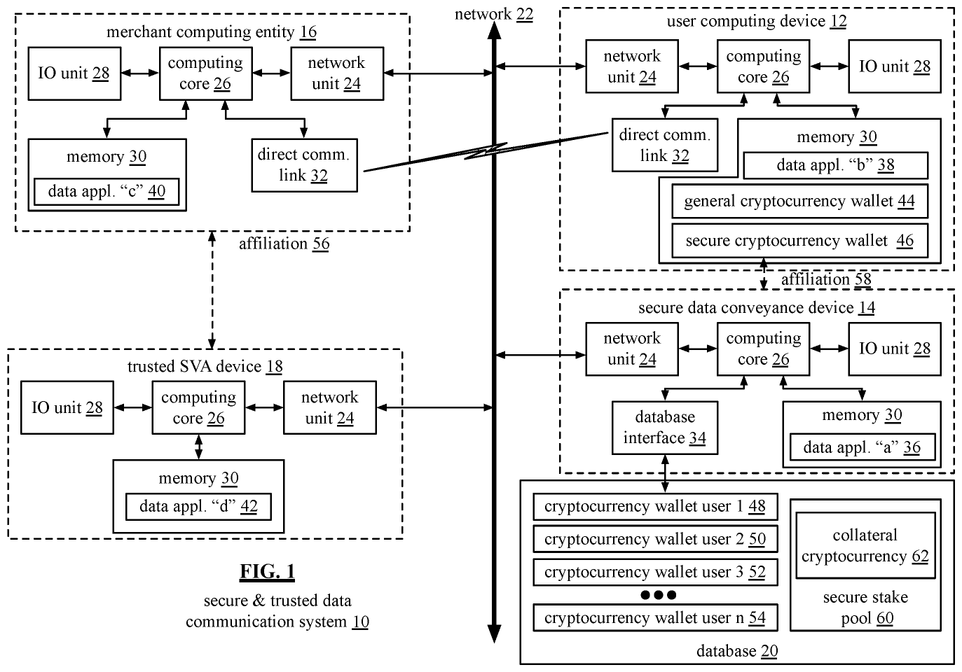

FIG. 1 is a schematic block diagram of an embodiment of a secure & trusted data communication system 10 that includes a user computing device 12, a secure data conveyance device 14, a merchant computing entity 16, a trusted stored value account (SVA) device 18, and a database 20. The secure & trusted data communication system 10 enables secure and trusted storage of cryptocurrency and secure and trusted financial transactions using cryptocurrency.

Cryptocurrency is a digital payment system based on distributed ledger technology (e.g., blockchain) where pseudo-anonymous transactions are open and public (i.e., anyone can join and view any transaction that has ever happened on the network). To minimize fraudulent activity and deter malicious network activity, the digital payment system implements “proof of work” secure hashing algorithms (SHA-256) that require significant computing power. While cryptocurrencies are primarily blockchain based, other distributed ledger technologies may be used. For example, Hashgraph uses an asynchronous consensus algorithm to enable a network of nodes to communicate with each other and reach consensus in a decentralized manner. Hashgraph does not need miners to validate transactions and uses directed acyclic graphs for time-sequencing transactions without bundling them into blocks.

Despite the anti-fraud benefits of cryptocurrencies, the value of cryptocurrency can be volatile (sometimes fluctuating dramatically over the course of a single day) and merchants are reluctant to invest in expensive point-of-sale and security upgrades to accommodate cryptocurrency payments. Further, many cryptocurrency payments are public for anyone to see. Customers may not wish to have their purchases made public and merchants may not wish to have consumer data made public for competitors. Yet merchants need to know who is purchasing goods from them and how often (e.g., for tax and legal reasons). As such, merchants have yet to widely accept cryptocurrency payments despite their potential benefits and consumers must primarily rely on present-day payment instruments. Some companies have developed digital wallets and apps that enable retail blockchain payments, but they are universally dependent on existing payment networks. The secure & trusted data communication system 10 addresses these issues.

The user computing device 12, the merchant computing entity 16, and the trusted stored value account (SVA) device 18 may be portable computing devices and/or a fixed computing devices. A portable computing device may be a social networking device, a gaming device, a cell phone, a smart phone, a digital assistant, a digital music player, a digital video player, a laptop computer, a handheld computer, a tablet, a video game controller, a portable merchant point-of-sale (POS) device (e.g., a mobile device with POS capabilities) and/or any other portable device that includes a computing core 26. A fixed computing device may be a computer (PC), a computer server, a cable set-top box, a satellite receiver, a television set, a printer, a fax machine, home entertainment equipment, a video game console, a fixed merchant point-of-sale (POS) device (e.g., cash register), and/or any type of home or office computing equipment.

The network 22 includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network and a WAN is the Internet, cellular telephone infrastructure, and/or satellite communication infrastructure.

Each of the user computing device 12, the merchant computing entity 16, and the trusted SVA device 18 includes a network unit 24, a computing core 26, an input/output (10) unit 28, and a memory 30. Each network unit 24 includes software and hardware to support one or more communication links via the network 22 directly and/or indirectly. For example, the network unit 24 of the computing device 12 supports a network 22 communication link between the computing device 12 and the devices 14-18. The computing cores 26 include one or more of: one or more processing modules, one or more main memories (e.g., RAM), a core control module, a video graphics processing module, an 10 control module, and a peripheral interface control module.

The 10 units 28 enable connections between devices 12-18 and user inputs/peripheral devices. Unit inputs/peripheral devices include one or more of an external hard drive, headset, a keypad, a keyboard, control switches, a touchpad, a speaker, a microphone, a thumb drive, a camera, etc.

The memories 30 include one or more of main memory (RAM), hard drives, solid-state memory chips, one or more other large capacity storage devices, and/or cache memory. The memories 30 store operational instructions for the computing cores 26. For example, user device 12 memory 30 stores data application “b” 38, the secure data conveyance device 14 memory 30 stores data application “a” 36, the merchant computing entity 16 memory 30 stores data application “c” 40, and the trusted SVA device 18 memory 30 stores data application “d” 42. The user computing device 12 memory 30 further stores general cryptocurrency wallet 44 and secure cryptocurrency wallet 46. The various applications stored by the devices support secure & trusted data communication within the system as described herein.

The database 20 is a special type of computing device that is optimized for large scale data storage and retrieval. The database 20 includes similar components to that of the devices 12-18 with more hard drive memory (e.g., solid state, hard drives, etc.) and potentially with more processing modules and/or main memory. Further, the database 20 is typically accessed remotely; as such it does not generally include user input devices and/or user output devices. An embodiment of a database 20 may include a standalone separate computing device and/or may be a cloud computing device.

The database 20 includes cryptocurrency wallets for users 1-n 48-54 and a secure stake pool 60. The secure data conveyance device 14 and the database 20 are secure devices implementing high level security protocols to prevent unauthorized use, hacking, etc. For example, the database 20 is a cryptocurrency holding company separate from the secure data conveyance device 14 that has been specially licensed to store sensitive materials and has insurance policies to protect against theft and fraud.

The secure stake pool 60 includes collateral cryptocurrency 62. The collateral cryptocurrency 62 is a known and trusted form of cryptocurrency that has been pledged by staking computing device of the secure & trusted data communication system 10 (e.g., digital wallet developers, users, etc.). For example, collateral cryptocurrency 62 is a system cryptocurrency specifically created for use within the secure & trusted data communication system 10. As another example, collateral cryptocurrency 62 is another type of cryptocurrency that was not developed by the system but is regularly used and is considered known and trusted.

The collateral cryptocurrency 62 may be used to back underfunded digital wallets wishing to be associated with the secure & trusted data communication system 10, to back new forms of cryptocurrencies, and/or to secure financial transactions (e.g., transactions may be completed with collateral cryptocurrency 62 when a transaction times out or fails). Staking computing devices are provided incentives to put up collateral cryptocurrency 62. For example, staking computing devices receive 1% back on all transactions. Further, a set amount of system cryptocurrency is generated. Because there is a finite amount of system cryptocurrency, the value of the system cryptocurrency will continue to grow and serve as further incentive for staking computing devices to obtain collateral cryptocurrency 62.

The user computing device 12 is associated with a user (e.g., user 1) and has an affiliation 58 with the secure data conveyance device 14. For example, the affiliation 58 is a user account. More specifically, the user computing device 12 is a user's smart phone and the affiliation 58 is a user account on a smart phone application 38 affiliating the user with the secure data conveyance device 14 for purposes of securely storing and spending cryptocurrency within the secure & trusted data communication system 10.

The secure data conveyance device 14 includes a database interface 34 that enables a connection between the secure data conveyance device 14 and the database 20. The user computing device 12 and the merchant computing entity 16 include a direct communication unit 32 that allows for a direct communication between them. For example, the direct communication unit 32 includes technology to establish a direct link between the user computing device 12 and the merchant computing entity 16 via video, infrared (IR), near-field communication (NFC), etc.

The merchant computing entity 16 includes one or more computing devices of the secure and trusted data communication system having an affiliation with a specific merchant identifier (ID). For example, the merchant computing entity 16 is a point of sale (POS) device in a retail store associated with a particular merchant having the specific merchant ID. The secure & trusted data communication system 10 supports secure, trusted, fraud-reduced financial transactions using cryptocurrency between a user computing device 12 and the merchant computing entity 16.

In an example of operation, user computing device 12 sets up a user account (e.g., affiliation 58) with secure data conveyance device 14 for the secure and trusted storage of cryptocurrency. Cryptocurrency is initially in a specific cryptocurrency format (e.g., Bitcoin).

The user computing device 12 initiates user account set-up (or other means of establishing affiliation 58) and downloads data application “b” 38 which includes instructions for cryptocurrency management, storage (e.g., management of the general cryptocurrency wallet 44 and the secure cryptocurrency wallet 46, etc.), and conveyance. The secure data conveyance device 14 memory 30 stores data application “a”, which has instructions for cryptocurrency management, conveyance, and storage via the database 20 (e.g., user cryptocurrency wallet creation and management, etc.). For example, upon user computing device 12 user account set up, the secure data conveyance device 14 generates one or more cryptocurrency wallets associated with the user computing device 12 in the database 20. For example, the secure data conveyance device 14 generates the cryptocurrency wallet user 1 48 in the database 20 for secure storage of the user computing device 12′s cryptocurrency.

The secure data conveyance device 14 securely stores cryptocurrency on behalf of the user computing device 12 so that the user computing device 12 maintains a representation of the cryptocurrency (e.g., a ghost image) but does not store the cryptocurrency itself. For example, the user computing device 12 has cryptocurrency stored in its general cryptocurrency wallet 44 of memory 30. The user computing device 12 sets up a user account with the secure data conveyance device 14 and sends at least a portion of the cryptocurrency (hereinafter for FIG. 1 referred to as transferred cryptocurrency) to the secure data conveyance device 14 using a secure one-way transmission (e.g., distributed ledger technology (DLT) (e.g., a blockchain, block directed acyclic graphs (blockDAG), transaction-based directed acyclic graphs (TDAG), etc.)) for secure storage. A secure one-way transmission is a transmission that cannot be undone and/or tampered with.

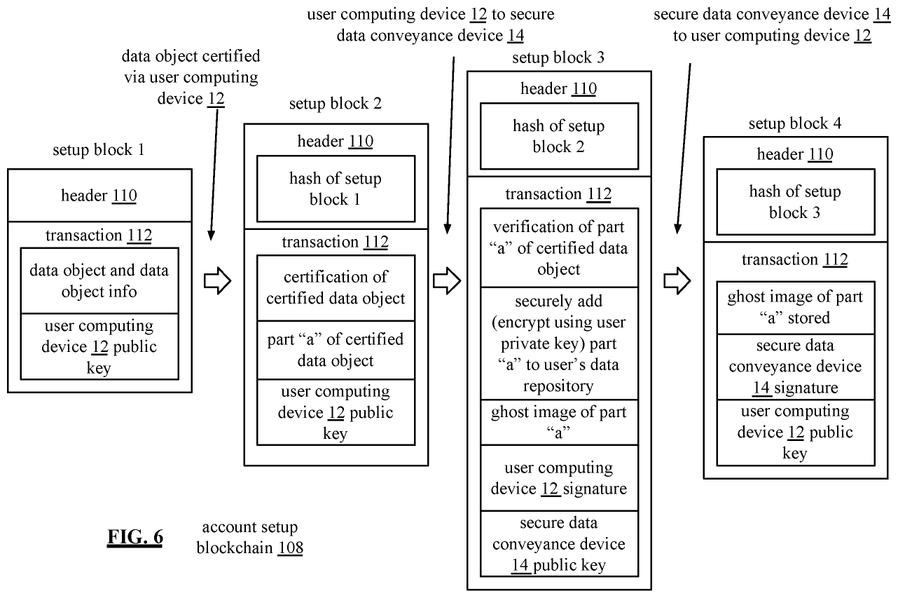

For example, distributed ledger technology (DLT), such as a blockchain, is an immutable ledger for recording transactions within a network, consisting of a continuously growing list of blocks (i.e., groups of transactions) that are securely linked, continually reconciled, and shared among all network participants. Transactions are validated and added to blocks via hashing algorithms, and then permanently written to the chain via consensus of the entire network. Once recorded on the blockchain, transactions cannot be altered and are thus secure one-way transmissions. A more detailed discussion of blockchain data storage is discussed with reference to FIG. 6.

The secure data conveyance device 14 verifies certification of the transferred cryptocurrency and when verified, adds the transferred cryptocurrency to the user computing device 12's cryptocurrency wallet (e.g., cryptocurrency wallet user 1 48) in the database 20. For example, the database 20 is a custodial wallet (e.g., a cryptocurrency holding company) separate from the secure data conveyance device 14 that has been specially licensed to store sensitive materials and has insurance policies to protect against theft and fraud. A blockchain may be used to add the transferred cryptocurrency to the user computing device 12's cryptocurrency wallet 48 and the transferred cryptocurrency is securely stored. After a blockchain is used to store cryptocurrency for user computing device 12, the rest of the conveyance is considered “off-chain.” Therefore, conveyance information is not made public.

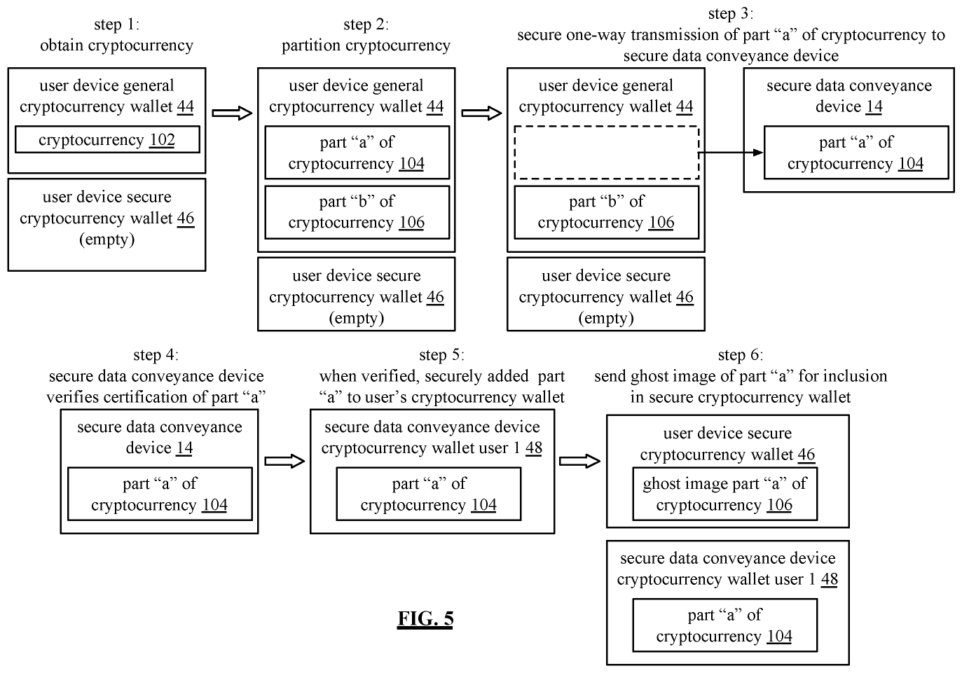

The secure data conveyance device 14 creates a ghost image of the transferred cryptocurrency and sends the ghost image to the user computing device 12 for storage within the user computing device 12′s secure cryptocurrency wallet 46. A more detailed discussion of account set up is discussed with reference to FIG. 5. After user account setup and secure storage of cryptocurrency with the secure data conveyance device 14, the user computing device 12 is ready to securely convey cryptocurrency to the merchant computing entity 16 in exchange for goods and/or services. The merchant computing entity 16 stores data application “c” in memory 30, which includes instructions for securely receiving cryptocurrency payments even if the merchant computing entity 16 would not normally receive cryptocurrency as a form of payment.

To begin a conveyance, user computing device 12 establishes a direct communication link with the merchant computing entity 16 via the direct communication link 32. The user computing device 12 sends the merchant computing entity 16 a request to initiate purchase of a product or service and payment using cryptocurrency. For example, each direct communication unit 32 includes near field communication (NFC) chips and when the user computing device 12 is within range of the merchant computing entity 16, the user computing device 12 can open a channel or tab to exchange cryptocurrency with the merchant computing entity 16.

The initiation of the conveyance may be done in a variety of ways. For example, the request to initiate conveyance may be in the form of a split bar code, where the user computing device 12 maintains one portion of a bar code and the merchant computing entity 16 maintains another portion of a bar code such that when they are aligned in close proximity, the conveyance is initiated. Having a correct piece of a barcode from the user computing device 12 as well as the act of alignment, demonstrates intent to enter into a transaction (i.e., user authorization). As another example, the request is a secure handshake protocol between the user computing device 12 and the merchant computing entity 16.

When the request to initiate conveyance is approved by the merchant computing entity 16 (e.g., via the split bar code example), the user computing device 12 receives a one-time use code (i.e., transaction ID) from the merchant computing entity 16. The one-time use code is one or more of: a unique number, an alpha numeric, a function, and/or any item that uniquely connects the parties in the transaction to the particular transaction. For example, the merchant computing entity 16 approves the request when the merchant computing entity 16 is affiliated with the trusted SVA device 18 and is otherwise capable of receiving the conveyance, the user computing device 12 is a trusted computing device (e.g., by verification of ID, certificate, etc.), etc.

The user computing device 12 sends the one-time use code plus an amount regarding the requested purchase to the secure data conveyance device 14. When approved, the secure data conveyance device 14 removes an amount of cryptocurrency from cryptocurrency wallet 48 to cover the purchase, translates the amount of cryptocurrency from specific cryptocurrency (e.g., Bitcoin) to fiat currency (e.g., digital representation of US dollars), and sends the fiat currency to the trusted SVA device 18. To send the fiat currency to trusted the SVA device 18, the secure data conveyance device 14 initiates a handshake with the trusted SVA device 18. For example, the secure data conveyance device 14 requests destination information from the trusted SVA device 18 and secure data conveyance device 14 validates the destination information. When the destination information is valid, the secure data conveyance device 14 establishes communication with the trusted SVA device 18 utilizing a secure communication technique.

The trusted SVA device 18 has an affiliation 56 with the merchant computing entity 16. For example, the merchant computing entity 16 has an account with the trusted SVA device 18. The trusted SVA device 18 stores data application “d” 42 in the memory 30, which includes instructions for creating SVAs for use by the merchant computing entity 16. The SVAs expire in a short period of time if not properly received by the merchant computing entity 16 and are only usable by the merchant computing entity 16.

The trusted SVA device 18 translates the fiat currency to an SVA that is only valid for this particular transaction and for this merchant computing entity 16 and sends the SVA to the secure data conveyance device 14. To send the SVA back to the secure data conveyance device 14, the trusted SVA device 18 initiates a handshake with the secure data conveyance device 14. For example, the trusted SVA device 18 requests destination information from the secure data conveyance device 14 and the trusted SVA device 18 validates the destination information. When the destination information is valid, the trusted SVA device 18 establishes communication with the secure data conveyance device 14 utilizing a secure communication technique. The trusted SVA device 18 sends the SVA to the secure data conveyance device 14 utilizing the secure communication technique.

The secure data conveyance device 14 adds an expiration time frame to the SVA and sends the SVA with the expiration time frame, a code, and the merchant computing entity identifier (ID) to the user computing device 12. As such, the SVA can only be conveyed to the merchant computing entity 16 within a certain period of time (e.g., a few seconds, 30 seconds, one minute, or more). To send the SVA with the expiration time frame to the user computing device 12, the secure data conveyance device 14 initiates a handshake with the user computing device 12. For example, secure data conveyance device 14 requests destination information from user computing device 12 and secure data conveyance device 14 validates the destination information. When the destination information is valid, the secure data conveyance device 14 establishes communication with the user computing device 12 utilizing a secure communication technique. The secure data conveyance device 14 sends the SVA with the expiration time frame, code (e.g., conveyance ID), and the merchant computing entity identifier (ID) to the user computing device 12 utilizing the secure communication technique.

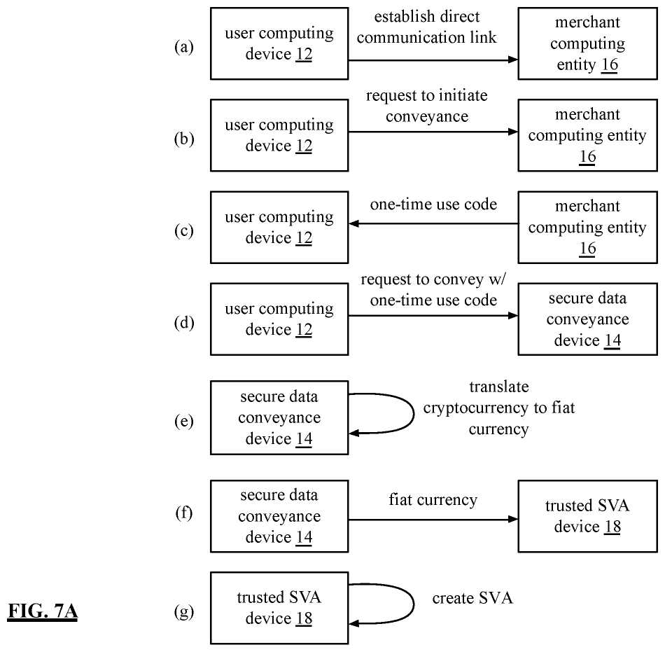

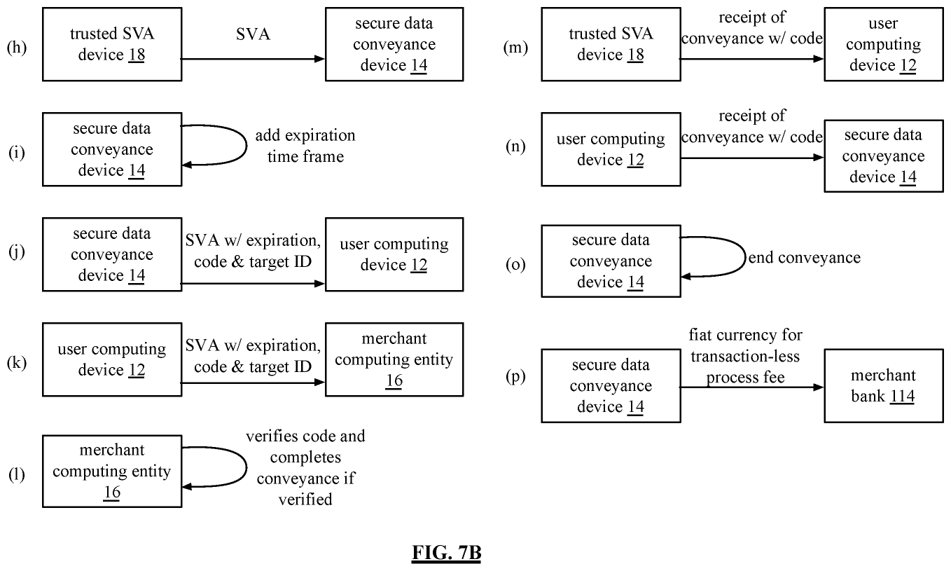

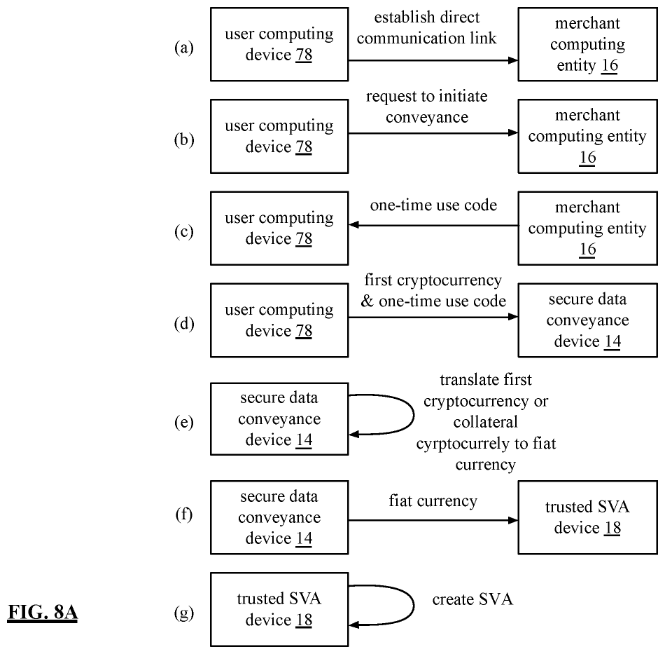

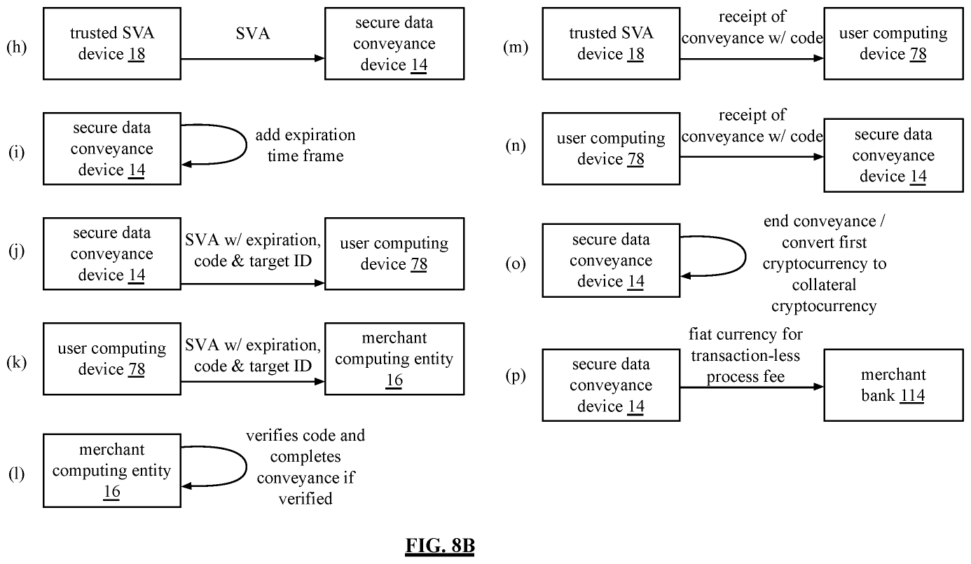

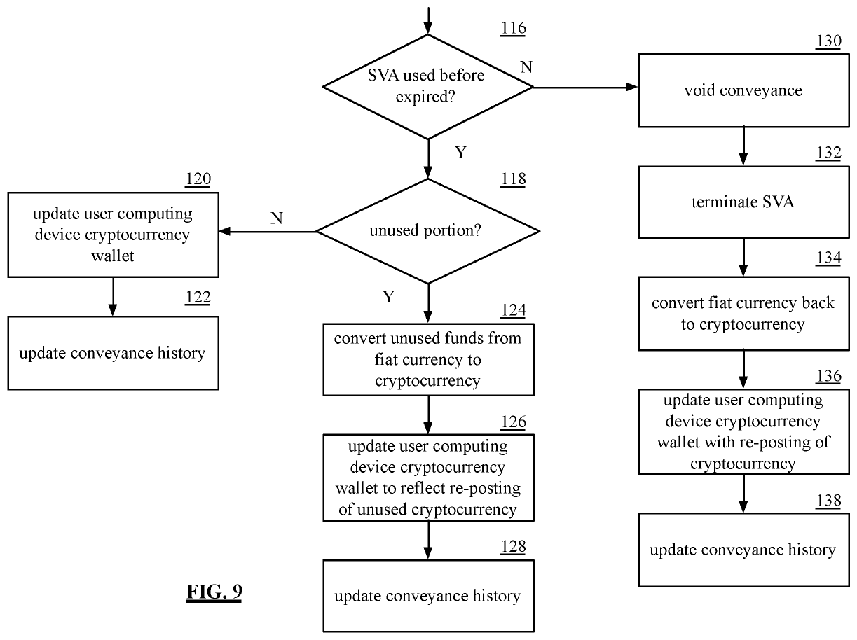

As such, the SVA is only transferable to the merchant computing entity 16 for a short time period (e.g., 30 seconds to one minute). Further, all the above steps happen very quickly in order to minimize the volatility aspects of cryptocurrency conversion. The user computing device 12 sends the SVA with the expiration time frame, a code, and the merchant computing entity identifier (ID) to the merchant computing entity 16. The merchant computing entity 16 verifies the code and ID and completes the conveyance if verified. Once complete, the user computing device 12 sends a confirmation (e.g., success, failure, time-out) to the secure data conveyance device 14 where the secure data conveyance device 14 ends the transaction. A more detailed discussion of cryptocurrency conveyance is discussed with reference to FIGS. 7A-8B. A more detailed discussion of ending the cryptocurrency conveyance is discussed with reference to FIG. 9.

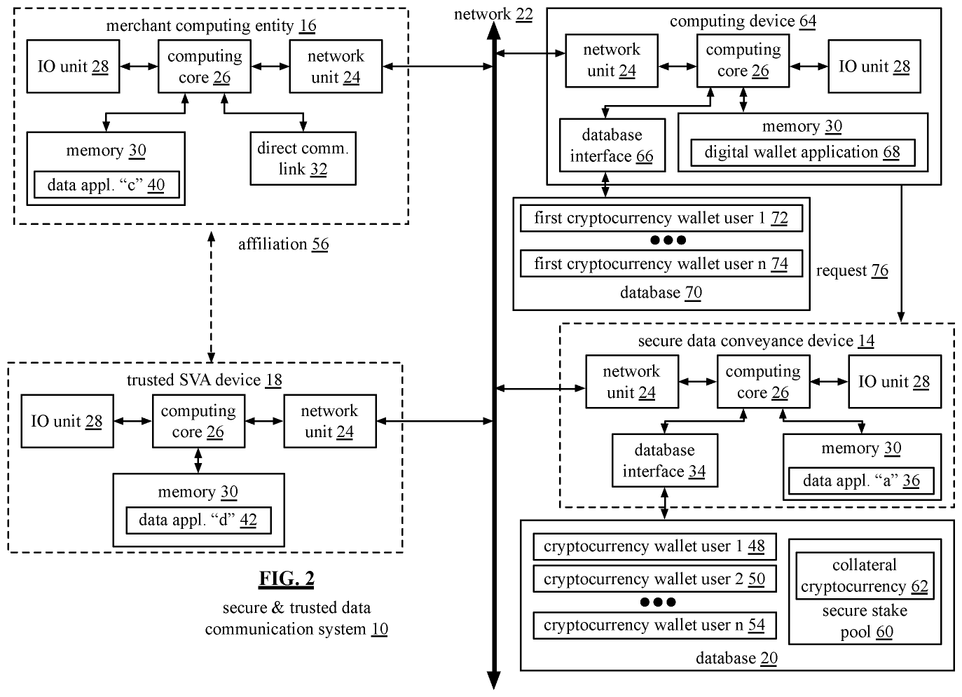

FIG. 2 is a schematic block diagram of another embodiment of the secure & trusted data communication system 10 that includes a computing device 64, the secure data conveyance device 14, the merchant computing entity 16, the trusted stored value account (SVA) device 18, the database 20, and a database 70. The secure & trusted data communication system 10 operates similarly to that of FIG. 1 except instead of including a user computing device 12 having affiliation 58 with the secure data conveyance device 14, FIG. 2 includes the computing device 64 which is not affiliated with the secure & trusted data communication system 10.

For example, the computing device 64 executes a digital wallet application (e.g., a digital wallet developer) that stores a first cryptocurrency on behalf of users associated with a digital wallet rendered by the digital wallet application. The first cryptocurrency is a type of cryptocurrency that may or may not be known and trusted to the secure & trusted data communication system 10. For example, the first cryptocurrency may be a new form of cryptocurrency developed for transactional use by the digital wallet application developer.

The computing device 64 may be portable computing device and/or a fixed computing device and includes a network unit 24, a computing core 26, an input/output (IO) unit 28, and a memory 30. The computing device 64 memory 30 stores digital wallet application 68 which has instructions for first cryptocurrency management, conveyance, and storage via database 70 (e.g., user first cryptocurrency wallet creation and management, etc.). For example, upon a user account set up, the computing device 64 generates one or more first cryptocurrency wallets associated with the user in database 70. For example, computing device 64 generates first cryptocurrency wallet user 1 72 in database 70 for storage of the user's first cryptocurrency.

The database 70 is a special type of computing device that is optimized for large scale data storage and retrieval. The database 70 includes similar components to that of the devices 14-18 and 64 with more hard drive memory (e.g., solid state, hard drives, etc.) and potentially with more processing modules and/or main memory. Further, the database 70 is typically accessed remotely; as such it does not generally include user input devices and/or user output devices. An embodiment of a database 70 may include a standalone separate computing device and/or may be a cloud computing device.

In an example of operation, the computing device 64 sends a request 76 to the secure data conveyance device 14. The request 76 is requesting a digital wallet rendered by the digital wallet application executed on the computing device 64 to be recognized and accepted within the secure and trusted data communication system 10 for purposes of financial transactions using the first cryptocurrency.

In response to the request 76, the secure data conveyance device 14 verifies that the first cryptocurrency is a valid form of cryptocurrency in accordance with a validation protocol. For example, the validation protocol is a procedure that verifies whether a confirmation speed of the first cryptocurrency meets a performance threshold (e.g., where confirmation speed is based on one or more of a transaction time of the first cryptocurrency and a block size first cryptocurrency), whether the secure data conveyance device 14 recognizes the first cryptocurrency as a known and trusted cryptocurrency (e.g., the secure data conveyance device 14 has interacted with the first cryptocurrency and/or the underlying blockchain technology that the first cryptocurrency is relying on (e.g., when the first cryptocurrency is a token using another cryptocurrency blockchain rather than its own native blockchain) on prior occasions with success), and/or whether the secure data conveyance device 14 recognizes the digital wallet application executed by the computing device 64 as valid and/or meets an integrity threshold (i.e., because the digital wallet application is valid, the first cryptocurrency should be trustworthy).

When the secure data conveyance device 14 verifies that the first cryptocurrency is a valid form of cryptocurrency, the secure data conveyance device 14 establishes a per unit value of the first cryptocurrency based on a per unit value of a known and trusted cryptocurrency of the system. For example, the secure data conveyance device 14 establishes a per unit value of the first cryptocurrency based on a system cryptocurrency. As another example, the secure data conveyance device 14 establishes a per unit value of the first cryptocurrency based on another cryptocurrency that is known and trusted (e.g., Bitcoin).

The secure data conveyance device 14 obtains a set of units of collateral cryptocurrency 62 from the secure stake pool 60 for a plurality of units of first cryptocurrency based on the established per unit value of the first cryptocurrency. Obtaining the set of units of collateral cryptocurrency 62 secures transactions utilizing the first cryptocurrency. The obtaining the set of units of collateral cryptocurrency 62 may include designating the set of units of collateral cryptocurrency 62 from collateral cryptocurrency 62 stored in the secure stake pool 60 that has been pledged by another computing device of the secure & trusted data communication system 10 (e.g., another trusted digital application developer) and/or receiving the set of units of collateral cryptocurrency 62 from the computing device 64 to back its own transactions.

With the first cryptocurrency backed by collateral cryptocurrency 62, the digital wallet rendered by the digital wallet application executed on the computing device 64 is recognized and accepted within the secure and trusted data communication system 10 for purposes of financial transactions using the first cryptocurrency.

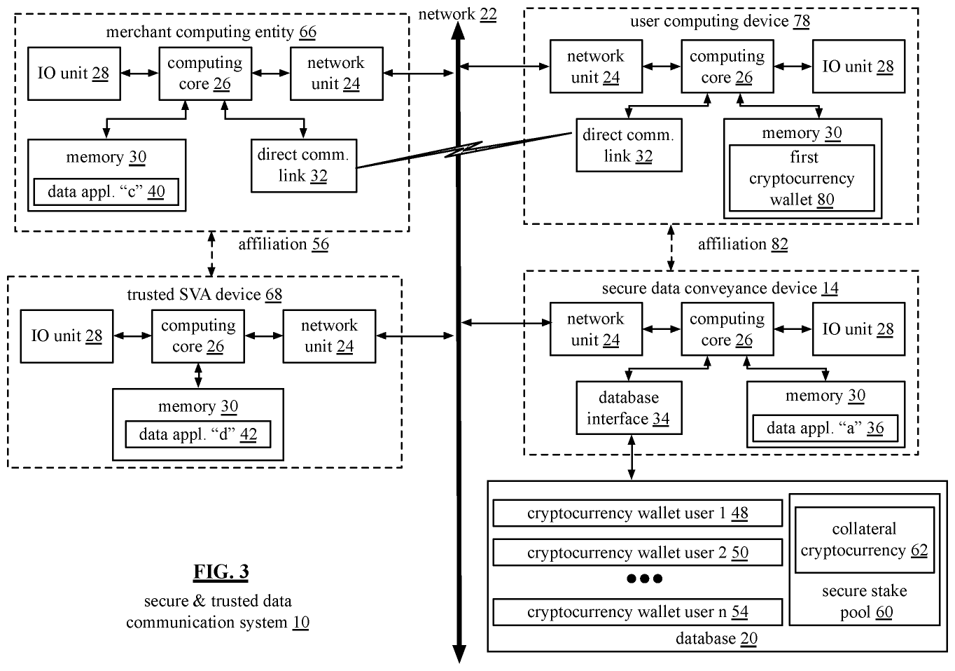

FIG. 3 is a schematic block diagram of another embodiment of the secure & trusted data communication system 10 that includes a user computing device 78, the secure data conveyance device 14, the merchant computing entity 16, the trusted stored value account (SVA) device 18, and the database 20. FIG. 3 operates similarly to FIG. 1 except that FIG. 3 illustrates an example where a user computing device 78 wishes to securely convey first cryptocurrency referenced in FIG. 2 from a first cryptocurrency wallet 80 to a merchant computing entity 16 via the secure & trusted data communication system 10 (i.e., the secure data conveyance device 14 does not store the first cryptocurrency on behalf of the user computing device 14 but the first cryptocurrency is trusted based on the method discussed with reference to FIG. 2).

The user computing device 78 includes a network unit 24, a computing core 26, an input/output (10) unit 28, memory 30, and a direct communication link 32. The user computing device's memory 30 stores the first cryptocurrency wallet 80. First cryptocurrency may be stored directly in cryptocurrency wallet 80 or on behalf of the user computing device 78 in the user's first cryptocurrency wallet of database 70 of FIG. 2.

The user computing device 78 is associated with a user and has an affiliation 82 with the secure data conveyance device 14. For example, the computing device 64 of FIG. 2 established affiliation 82 for all users (i.e., including user computing device 78) of first cryptocurrency digital wallets rendered by the digital wallet application executed on computing device 64.

To begin a conveyance, the user computing device 78 establishes a direct communication link with the merchant computing entity 16 via the direct communication link 32. The user computing device 78 sends the merchant computing entity 16 a request to initiate purchase of a product or service and payment using the first cryptocurrency. For example, each direct communication unit 32 includes near field communication (NFC) chips and when user computing device 78 is within range of the merchant computing entity 16, the user computing device 78 can open a channel or tab to exchange the first cryptocurrency with the merchant computing entity 16.

When the request to initiate conveyance is approved by the merchant computing entity 16 (e.g., via the split bar code example), the user computing device 78 receives a one-time use code (i.e., transaction ID) from the merchant computing entity 16. The one-time use code is one or more of: a unique number, an alpha numeric, a function, and/or any item that uniquely connects the parties in the transaction to the particular transaction. For example, the merchant computing entity 16 approves the request when the merchant computing entity 16 is affiliated with the trusted SVA device 18 and is otherwise capable of receiving the conveyance, the user computing device 78 is a trusted computing device (e.g., by verification of ID, certificate, etc.), etc.

The user computing device 78 sends the one-time use code plus the amount of first cryptocurrency to cover the requested purchase to the secure data conveyance device 14. Alternatively, the user computing device 78 sends the one-time use code and the secure data conveyance device 14 requests the amount of first cryptocurrency to cover the requested purchase from the user computing device 78. If the amount of first cryptocurrency to cover the requested purchase from the user computing device 78 is not received within a period of time (e.g., the request times out, the first cryptocurrency wallet 80 fails (e.g., experiences a bug, fraud, etc.)) the secure data conveyance device 14 may obtain an amount of collateral cryptocurrency 62 of the set of units of collateral cryptocurrency from secure stake pool 60 substantially equal to the amount of first cryptocurrency to cover the requested purchase in a timely manner. When and if the amount of first cryptocurrency to cover the requested purchase from the user computing device 78 comes through after the period of time, the amount of the first cryptocurrency can be converted to collateral cryptocurrency and stored in secure stake pool 62 to cover what was taken out.

The secure data conveyance device 14 translates the amount of first cryptocurrency (or collateral cryptocurrency under the circumstances mentioned above) from specific cryptocurrency (e.g., the first cryptocurrency) to fiat currency (e.g., digital representation of US dollars), and sends the fiat currency to the trusted SVA device 18.

The trusted SVA device 18 has an affiliation 56 with the merchant computing entity 16 as discussed with reference to FIG. 1 and creates SVAs for use by the merchant computing entity 16. The SVAs expire in a short period of time if not properly received by the merchant computing entity 16 and are only usable by the merchant computing entity 16.

The trusted SVA device 18 translates the fiat currency to an SVA that is only valid for this particular transaction and for this merchant computing entity 16 and sends the SVA to the secure data conveyance device 14. The trusted SVA device 18 sends the SVA to the secure data conveyance device 14 utilizing the secure communication technique discussed with reference to FIG. 1.

The secure data conveyance device 14 adds an expiration time frame to the SVA and sends the SVA with the expiration time frame, a code, and the merchant computing entity identifier (ID) to the user computing device 78. As such, the SVA can only be conveyed to the merchant computing entity 16 within a certain period of time (e.g., a few seconds, 30 seconds, one minute, or more). To send the SVA with the expiration time frame to the user computing device 78, the secure data conveyance device 14 initiates a secure handshake with the user computing device 78 as discussed with reference to FIG. 1. For example, secure data conveyance device 14 requests destination information from user computing device 78 and secure data conveyance device 14 validates the destination information. The secure data conveyance device 14 sends the SVA with the expiration time frame, code (e.g., conveyance ID), and the merchant computing entity identifier (ID) to the user computing device 78 utilizing the secure communication technique.

As such, the SVA is only transferable to the merchant computing entity 16 for a short time period (e.g., 30 seconds to one minute). Further, all the above steps happen very quickly in order to minimize the volatility aspects of cryptocurrency conversion. The user computing device 78 sends the SVA with the expiration time frame, a code, and the merchant computing entity identifier (ID) to the merchant computing entity 16. The merchant computing entity 16 verifies the code and ID and completes the conveyance if verified. Once complete, the user computing device 78 sends a confirmation (e.g., success, failure, time-out) to the secure data conveyance device 14 where the secure data conveyance device 14 ends the transaction (e.g., ending the transaction may include converting first cryptocurrency that is received after the period of time to collateral cryptocurrency to cover what was take out to complete the transaction in a timely manner). A more detailed discussion of cryptocurrency conveyance is discussed with reference to FIGS. 7A-8B. A more detailed discussion of ending the cryptocurrency conveyance is discussed with reference to FIG. 9.

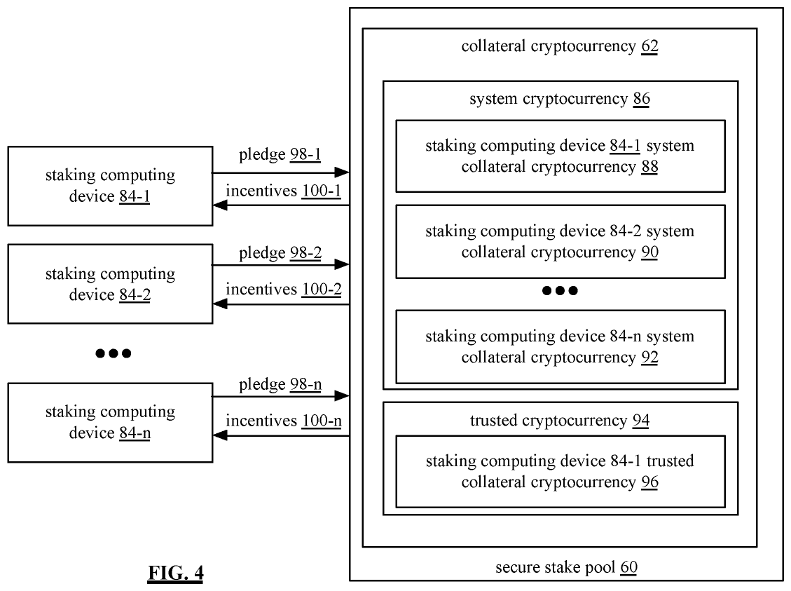

FIG. 4 is a schematic block diagram of an example of a secure stake pool 60. The secure stake pool 60 includes collateral cryptocurrency 62. The collateral cryptocurrency 62 is a known and trusted form of cryptocurrency that has been pledged by staking computing devices 84-1 through 84-n of the secure & trusted data communication system 10 (e.g., digital wallet developers, users, etc.). For example, collateral cryptocurrency 62 is a system cryptocurrency 82 specifically created for use within the secure & trusted data communication system 10. As another example, collateral cryptocurrency 62 is another type of cryptocurrency that was not developed by the system but is regularly used and is considered known and trusted (e.g., trusted cryptocurrency 94).

Collateral cryptocurrency 62 may be used to back underfunded digital wallets wishing to be associated with the secure & trusted data communication system 10, to back new forms of cryptocurrencies, and/or to secure financial transactions (e.g., transactions may be completed with collateral cryptocurrency 62 when a transaction times out or fails).

Staking computing devices 84-1 through 84-n execute digital wallet applications and have pledged (e.g., pledges 98-1 through 100-n) collateral cryptocurrency 62 back a digital wallet (e.g., their own digital wallet or another developer's digital wallet). For example, staking computing device 84-1 submits a pledge 98-1 consisting of system collateral cryptocurrency 88 as well as a pledge 98-1 of trusted collateral cryptocurrency 96. Once a staking computing device 84-1 through 84-n pledges collateral cryptocurrency, the pledged collateral cryptocurrency is owned and controlled by the secure conveyance device 14 via the secure stake pool 60.

A staking computing device may pledge collateral cryptocurrency to back its own digital wallet and/or may pledge collateral cryptocurrency to back another digital wallet application's digital wallet. In return for pledging collateral cryptocurrency, the staking computing devices 84-1 through 84-n are provided incentives 100-1 through 100-n. For example, staking computing devices 84-1 through 84-n receive 1% back on all transactions. Further, a set amount of system cryptocurrency 86 is generated. Because there is a finite amount of system cryptocurrency, the value of the system cryptocurrency will continue to grow and serve as further incentive for the staking computing devices 84-1 through 84-n to obtain collateral cryptocurrency 62.

FIG. 5 is a schematic block diagram of an embodiment of a user computing device 12 setting up an account with secure data conveyance device 14 with reference to the example of FIG. 1. Prior to the steps listed, user computing device 12 obtains application “b” 38 and establishes affiliation 58 with secure data conveyance device 14 (e.g., initiates a user account with secure data conveyance device 14). At step 1, user computing device 12 obtains cryptocurrency 102 where it is stored in user computing device 12's general cryptocurrency wallet 44. User computing device 12's secure cryptocurrency wallet 46 is currently empty. Cryptocurrency is a data object that has been certified via a blockchain. A more detailed discussion of blockchain data storage is discussed with reference to FIG. 6.

At step 2, user computing device 12 partitions the cryptocurrency 102 into parts “a” and “b.” Part “a” of cryptocurrency 104 is the amount of cryptocurrency user computing device 12 wishes to convey. Therefore, part “a” of cryptocurrency 104 may be some or all of the cryptocurrency 102 and part “b” of cryptocurrency 106 may be some or none of the cryptocurrency 102.

At step 3, user computing device 12 sends part “a” of cryptocurrency 104 to secure data conveyance device 14 via a secure one-way transmission (e.g., using a blockchain). At step 4, secure data conveyance device 14 verifies certification of part “a” of cryptocurrency 104. When verified, secure data conveyance device 14 securely adds part “a” of cryptocurrency 104 to secure data conveyance device cryptocurrency wallet for user 1 48 at step 5. For example, a blockchain is used to add part “a” of cryptocurrency 104 to cryptocurrency wallet for user 1 48 and part “a” of cryptocurrency 104 is encrypted using a private key of user computing device 12.

At step 6, the secure data conveyance device 14 sends a ghost image of part “a” of cryptocurrency 106 to user computing device 12 for storage in secure cryptocurrency wallet 46. As shown, the real data (part “a” of cryptocurrency 104) is stored in secure data conveyance device cryptocurrency wallet for user 1 48 while a representation of the data (the ghost image of “a” of cryptocurrency 106) is stored in the user computing device 12's secure cryptocurrency wallet 46. Therefore, the user computing device 12 has an image of what is in the secure data conveyance device 14 and cannot undo the transfer (e.g., because transactions are secured on a blockchain).

FIG. 6 is a schematic block diagram of a user computing device 12 setting up an account with secure data conveyance device blockchain 108 (“account setup blockchain 108”). Each participant in the account setup blockchain 108 is assigned a private key to make transactions with and once transactions are complete, participants can verify the transactions using public keys. Thus, each transaction is digitally signed (via a combination of private and public keys) to ensure authenticity and that transactions are not tampered with. Each block in the account setup blockchain 108 includes a header section 110 and a transaction section 112. Header section 110 includes one or more of identifying information, a nonce, and a hash of a preceding block when there is a preceding block. Transaction section 112 includes one or more of a public key of the device currently interacting with a blockchain, a signature of a preceding device, one or more transactions and corresponding transaction information (e.g., timestamp, etc.), and data involved in the one or more transactions.

The user computing device 12 generates setup block 1 upon initial account set up. Setup block 1 transaction section 112 includes a data object (e.g., that is stored in user computing device's general data repository), data object information (e.g., where the data object was obtained, type of data object, etc.), and the user computing device 12'a public key. Setup block 2's header section 110 includes a hash of setup block 1. Setup block 2's transaction section 112 includes transaction information regarding certification of the data object. For example, the user computing device 12 encrypts the data object via user computing device's private key and generates a digital signature for the encryption. Setup block 2 transaction section 112 further includes transaction information regarding partitioning the certified data object, part “a” of the certified data object (as a result of the partitioning), and user computing device 12's public key.

User computing device 12 sends setup block 2 to secure data conveyance device 14. Secure data conveyance device 14 generates setup block 3. Setup block 3 header section 110 includes a hash of setup block 2. Setup block 3 transaction section 112 includes transaction information regarding verification of part “a” of the certified data object (e.g., certified data object is verified using user computing device 12's public key), transaction information regarding securely adding part “a” of certified data object to secure data conveyance device data repository for user 1 (e.g., the certified data object is encrypted using user computing device 12's private key), information regarding creating and sending a ghost image of part “a” of certified data object to user computing device for storage, and the ghost image of part “a” of certified data object. Setup block 3 transaction section 112 also includes user computing device 12's signature and secure data conveyance device 14's public key.

The secure data conveyance device 14 sends setup block 3 to the user computing device 12. The user computing device 12 generates setup block 4. Setup block 4 header section 104 includes a hash of setup block 3. Setup block 4 transaction section 106 includes transaction information regarding storage of the ghost image of part “a” of certified data object in user computing device's secure data repository, secure data conveyance device 14's signature, and user computing device 12's public key. Because data is transferred and stored using a blockchain, the transfer and storage is public and tamper-proof.

FIGS. 7A-7B are flowcharts of a method of conveying cryptocurrency with reference to the secure & trusted data communication system of FIG. 1. FIG. 7A begins with step (a) where the user computing device 12 establishes a direct communication link with the merchant computing entity 16.

At step (b), user computing device 12 sends merchant computing entity 16 a request to initiate conveyance of at least a portion of the cryptocurrency to the merchant computing entity 16 via the direct communication link. When the request to initiate conveyance is approved by the merchant computing entity 16, the merchant computing entity 16 sends the user computing device 12 a one-time use code regarding conveyance of the at least a portion of the cryptocurrency at step (c).

At step (d), the user computing device 12 sends the one-time use code plus a request to convey the at least a portion of the cryptocurrency to the secure data conveyance device 14. When approved, the secure data conveyance device 14 translates the at least a portion of the cryptocurrency from a specific type of cryptocurrency (e.g., Bitcoin) to fiat currency. At step (e), the secure data conveyance device 14 sends the fiat currency to the trusted stored value account (SVA) device 18 (e.g., via a secure communication technique). The trusted SVA device 18 has an affiliation with the merchant computing entity 16. At step (g), the trusted SVA device 18 translates the fiat currency to a stored value account (SVA) for the user computing device 12.

The method continues with step (h) on FIG. 7B where the trusted SVA device 18 sends the SVA to the secure data conveyance device 14 (e.g., via a secure communication technique). At step (i), the secure data conveyance device 14 adds an expiration time frame to the SVA. For example, the secure data conveyance device 14 adds an expiration time frame of 30 seconds for the user to complete the conveyance with the SVA.

At step (j), the secure data conveyance device 14 sends the SVA with the expiration time frame, code, and the merchant computing entity identifier (ID) to the user computing device 12 (e.g., via a secure communication technique). At step (k), the user computing device 12 sends the SVA with the expiration time frame, code, and the merchant computing entity identifier (ID) to the merchant computing entity 16 via the direct communication link (e.g., a split bar code).

At step (l), the merchant computing entity 16 verifies the code and ID and completes the conveyance if verified. Once complete, the merchant computing entity 16 sends the user computing device 12 a receipt of the conveyance with a code at step (m). At step (n), the user computing device 12 sends a confirmation (e.g., success, failure, time-out) of the conveyance to secure data conveyance device 14. At step (o), the secure data conveyance device 14 ends the conveyance. A more detailed discussion of ending the conveyance is discussed with reference to FIG. 9. At step (p), the secure data conveyance device 14 sends fiat currency for a transaction-less processing fee to the merchant bank 114.

FIGS. 8A-8B are flowcharts of a method of conveying first cryptocurrency with reference to the secure & trusted data communication system of FIG. 3. FIG. 8A begins with step (a) where the user computing device 78 establishes a direct communication link with the merchant computing entity 16.

At step (b), the user computing device 78 sends the merchant computing entity 16 a request to initiate conveyance of an amount of first cryptocurrency to the merchant computing entity 16 via the direct communication link to cover a requested purchase. When the request to initiate conveyance is approved by the merchant computing entity 16, the merchant computing entity 16 sends the user computing device 78 a one-time use code regarding conveyance of the amount of first cryptocurrency at step (c).

At step (d), the user computing device 78 sends the one-time use code plus the amount of first cryptocurrency to cover the requested purchase to the secure data conveyance device 14. Alternatively, the user computing device 78 sends the one-time use code and the secure data conveyance device 14 requests the amount of first cryptocurrency to cover the requested purchase from the user computing device 78. If the amount of first cryptocurrency to cover the requested purchase from the user computing device 78 is not received within a certain time period (e.g., the request times out, the first cryptocurrency wallet 80 fails (e.g., experiences a bug, fraud, etc.)) the secure data conveyance device 14 may obtain an amount of collateral cryptocurrency 62 of the set of units of collateral cryptocurrency from secure stake pool 60 substantially equal to the amount of first cryptocurrency to cover the requested purchase in a timely manner. When and if the amount of first cryptocurrency to cover the requested purchase from the user computing device 78 comes through after the certain time period, the amount of the first cryptocurrency can be converted to collateral cryptocurrency and stored in the secure stake pool 62 to cover what was taken out.

When approved, the secure data conveyance device 14 translates the amount of the first cryptocurrency or the collateral cryptocurrency from a specific type of cryptocurrency to fiat currency. At step (e), the secure data conveyance device 14 sends the fiat currency to the trusted stored value account (SVA) device 18 (e.g., via a secure communication technique). The trusted SVA device 18 has an affiliation with the merchant computing entity 16. At step (g), the trusted SVA device 18 translates the fiat currency to a stored value account (SVA) for the user computing device 78.

The method continues with step (h) on FIG. 8B where the trusted SVA device 18 sends the SVA to the secure data conveyance device 14 (e.g., via a secure communication technique). At step (i), secure data conveyance device 14 adds an expiration time frame to the SVA. For example, secure data conveyance device 14 adds an expiration time frame of 30 seconds for the user to complete the conveyance with the SVA.

At step (j), the secure data conveyance device 14 sends the SVA with the expiration time frame, code, and the merchant computing entity identifier (ID) to the user computing device 78 (e.g., via a secure communication technique). At step (k), the user computing device 78 sends the SVA with the expiration time frame, code, and the merchant computing entity identifier (ID) to the merchant computing entity 16 via the direct communication link (e.g., a split bar code).

At step (l), the merchant computing entity 16 verifies the code and ID and completes the conveyance if verified. Once complete, the merchant computing entity 16 sends the user computing device 78 a receipt of the conveyance with a code at step (m). At step (n), the user computing device 78 sends a confirmation (e.g., success, failure, time-out) of the conveyance to the secure data conveyance device 14. At step (o), the secure data conveyance device 14 ends the conveyance. If collateral cryptocurrency was used to cover the conveyance and the first cryptocurrency has now been received, the secure data conveyance device 14 further converts the amount of first cryptocurrency received to the amount of collateral cryptocurrency used to cover the amount used in the conveyance and stores it in the secure stake pool. A more detailed discussion of ending the conveyance is discussed with reference to FIG. 9. At step (p), the secure data conveyance device 14 sends fiat currency for a transaction-less processing fee to the merchant bank 114.

FIG. 9 is a flowchart of another method of ending a cryptocurrency conveyance by the secure data conveyance device. The method begins with step 116 where the secure data conveyance device determines whether the SVA has been used within the expiration time period. If the SVA has been used within the expiration time period, the method continues with step 118 where the secure data conveyance device determines whether there is an unused portion of the SVA remaining.

When there is no unused portion of the SVA remaining, the method continues with step 120 where the secure data conveyance device updates the user computing device cryptocurrency wallet to reflect the conveyance (e.g., the cryptocurrency conveyed is no longer in the cryptocurrency wallet). When the computing device is computing device 12, updating the user computing device cryptocurrency wallet also updates the secure cryptocurrency wallet of the user computing device (e.g., the secure data conveyance device sends the user computing device a message to delete the ghost image of the cryptocurrency used).

The method continues with step 122 where the secure data conveyance device updates the conveyance history. If collateral cryptocurrency was used to cover the conveyance and the first cryptocurrency has now been received, the secure data conveyance device 14 further converts the amount of first cryptocurrency received to the amount of collateral cryptocurrency used to cover the amount used in the conveyance and stores it in the secure stake pool to complete the transaction.

When there is an unused portion of the SVA remaining at step 118, method continues with step 124 where the secure data conveyance device data translates the unused portion of the SVA back to specific cryptocurrency. The method continues with step 126 where the secure data conveyance device updates the user computing device cryptocurrency wallet to reflect reposting of specific cryptocurrency. When the user computing device is user computing device 12, updating the user computing device cryptocurrency wallet, updates the secure cryptocurrency wallet of the user computing device (e.g., the secure data conveyance device sends the user computing device a new ghost image of the re-posted cryptocurrency). The method continues with step 128 where the secure data conveyance device updates the conveyance history. If collateral cryptocurrency was used to cover the conveyance and the first cryptocurrency has now been received, the secure data conveyance device 14 further converts the amount of first cryptocurrency received to the amount of collateral cryptocurrency used to cover the amount used in the conveyance and stores it in the secure stake pool to complete the transaction.

When the SVA has not been used before expiration of the expiration time frame at step 116, the method continues with step 130 where the secure data conveyance device voids the conveyance. The method continues with step 132 where the secure data conveyance device terminates the SVA. The method continues with step 134 where the secure data conveyance device translates fiat currency back to the specific cryptocurrency. The method continues with step 136 where the secure data conveyance device updates user computing device cryptocurrency wallet with re-posting of the specific cryptocurrency. When the user computing device is user computing device 12, updating the user computing device cryptocurrency wallet updates the secure cryptocurrency wallet of the user computing device (e.g., the secure data conveyance device sends the user computing device a new ghost image of the re-posted cryptocurrency). The method continues with step 138 where the secure data conveyance device updates the conveyance history to reflect a voided conveyance.

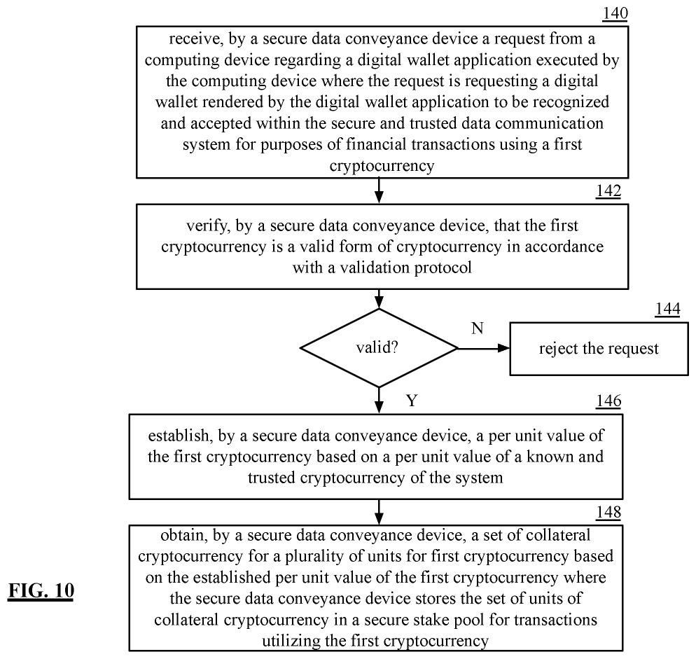

FIG. 10 is a flowchart of an example of a method of a secure stake pool in accordance with the present invention. The method begins with step 140 where a secure data conveyance device of a secure and trusted data communication system receives a request from a computing device regarding a digital wallet application executed by the computing device. The request is requesting a digital wallet rendered by the digital wallet application to be recognized and accepted within the secure and trusted data communication system for purposes of financial transactions using a first cryptocurrency.

The method continues with step 142 where the secure data conveyance device verifies that the first cryptocurrency is a valid form of cryptocurrency in accordance with a validation protocol. For example, the validation protocol is a procedure that verifies whether a confirmation speed of the first cryptocurrency meets a performance threshold (e.g., where confirmation speed is based on one or more of a transaction time of the first cryptocurrency and a block size first cryptocurrency), whether the secure data conveyance device recognizes the first cryptocurrency as a known and trusted cryptocurrency (e.g., the secure data conveyance device has interacted with the first cryptocurrency and/or the underlying blockchain technology that the first cryptocurrency is relying on (e.g., when the first cryptocurrency is a token using another cryptocurrency blockchain rather than its own native blockchain) on prior occasions with success), and/or whether the secure data conveyance device recognizes the digital wallet application executed by the computing device as valid and/or meets an integrity threshold (i.e., because the digital wallet application is valid, the first cryptocurrency should be trustworthy).

When the secure data conveyance device does not verify that the first cryptocurrency is a valid form of cryptocurrency, the method continues with step 144 where the request is rejected. When the secure data conveyance device verifies that the first cryptocurrency is a valid form of cryptocurrency, the method continues with step 146 where the secure data conveyance device establishes a per unit value of the first cryptocurrency based on a per unit value of a known and trusted cryptocurrency of the system. For example, the secure data conveyance device establishes a per unit value of the first cryptocurrency based on a system cryptocurrency. As another example, the secure data conveyance device establishes a per unit value of the first cryptocurrency based on another cryptocurrency that is known and trusted (e.g., Bitcoin).

The method continues with step 148 where the secure data conveyance device obtains a set of units of collateral cryptocurrency for a plurality of units of first cryptocurrency based on the established per unit value of the first cryptocurrency. Obtaining the set of units of collateral cryptocurrency secures transactions utilizing the first cryptocurrency. The collateral cryptocurrency is a known and trusted form of cryptocurrency that has been pledged by one or more staking computing device of the secure & trusted data communication system (e.g., digital wallet developers, users, etc.). For example, collateral cryptocurrency is a system cryptocurrency specifically created for use within the secure & trusted data communication system. As another example, collateral cryptocurrency is another type of cryptocurrency that was not developed by the system but is regularly used and is considered known and trusted.

The secure data conveyance device stores the set of units of collateral cryptocurrency in a secure stake pool for transactions utilizing the first cryptocurrency. The obtaining the set of units of collateral cryptocurrency may include designating the set of units of collateral cryptocurrency from collateral cryptocurrency already stored in the secure stake pool that has been pledged by another computing device of the secure & trusted data communication system 10 (e.g., a digital application developer) and/or receiving the set of units of collateral cryptocurrency from the computing device to back its own transactions.

Collateral cryptocurrency may be used to back underfunded digital wallets wishing to be associated with the secure & trusted data communication system, to back new forms of cryptocurrencies, and/or to secure financial transactions (e.g., transactions may be completed with collateral cryptocurrency when a transaction times out or fails). Staking computing devices are provided incentives to put up collateral cryptocurrency. For example, staking computing devices receive 1% back on all transactions. Further, a set amount of system cryptocurrency is generated. Because there is a finite amount of system cryptocurrency, the value of the system cryptocurrency will continue to grow and serve as further incentive for staking computing devices to obtain collateral cryptocurrency.

With the first cryptocurrency backed by collateral cryptocurrency, the digital wallet rendered by the digital wallet application executed on the computing device is recognized and accepted within the secure and trusted data communication system for purposes of financial transactions using the first cryptocurrency

With reference to one or more of the embodiments and/or examples discussed above, data is securely conveyed within system 10 in a trusted and secure manner while substantially reducing the fraud. With the use of one-way secure transmissions, secure communication techniques, one or more data translations, a transaction identifier, a secure computing device, a trusted data securing device, and/or direct link communication, a user computing device can securely convey data to a target computing device and both devices can trust that the other device is a valid (non-fraudulent) device and is authorized to participate the data conveyance.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
receiving, by a secure data conveyance device of a secure and trusted data communication system, a request from a computing device regarding a digital wallet application executed by the computing device, wherein the request is requesting a digital wallet rendered by the digital wallet application to be recognized and accepted within the secure and trusted data communication system for purposes of financial transactions using a first cryptocurrency;
verifying, by the secure data conveyance device, that the first cryptocurrency is a valid form of cryptocurrency in accordance with a validation protocol;
when the first cryptocurrency is a valid form of cryptocurrency:
establishing, by the secure data conveyance device, a per unit value of the first cryptocurrency based on a per unit value of a known and trusted cryptocurrency of the system; and
obtaining, by the secure data conveyance device, a set of units of collateral cryptocurrency for a plurality of units of first cryptocurrency based on the established per unit value of the first cryptocurrency, wherein the secure data conveyance device stores the set of units of collateral cryptocurrency in a secure stake pool for transactions utilizing the first cryptocurrency.

2. The method of claim 1 further comprises:
receiving, by the secure data conveyance device, a conveyance request from a user computing device of the secure and trusted data communication system, wherein the user computing device includes a first cryptocurrency digital wallet rendered by the digital wallet application for storage of the first cryptocurrency, wherein the conveyance request requests that a specific amount of the first cryptocurrency be conveyed to a merchant computing entity of the secure and trusted data communication system;
when the conveyance request is authenticated:
obtaining, by the secure data conveyance device, the specific amount of the first cryptocurrency from the first cryptocurrency digital wallet;
converting, by the secure data conveyance device, the specific amount of the first cryptocurrency into a specific amount of fiat currency;
sending, by the secure data conveyance device, the specific amount of fiat currency to a trusted stored value account (SVA) device of the secure and trusted data communication system;
converting, by the trusted SVA device, the specific amount of fiat currency into an SVA, wherein the SVA is only usable by the merchant computing entity;
sending, by the trusted SVA device, the SVA to the secure data conveyance device;
adding, by the secure data conveyance device, an expiration time frame to the SVA;
forwarding, by the secure data conveyance device, the SVA with the expiration time frame to the user computing device; and
conveying, by the user computing device via a direct communication link, the SVA with the expiration time frame to the merchant computing entity when data conveyance between the user computing device and the merchant computing entity is confirmed.

3. The method of claim 2, wherein the obtaining the specific amount of the first cryptocurrency from the first cryptocurrency digital wallet further comprises:
requesting, by the secure data conveyance device, the specific amount of the first cryptocurrency from the user computing device; and
when the specific amount of the first cryptocurrency is not received from the user computing device within a time period:
obtaining, by the secure data conveyance device, a specific amount of collateral cryptocurrency of the set of units of collateral cryptocurrency substantially equal to the specific amount of the first cryptocurrency in order to complete the conveyance request.

4. The method of claim 3 further comprises:
when the specific amount of the first cryptocurrency is received from the user computing device after the time period:
converting, by the secure data conveyance device, the specific amount of the first cryptocurrency to the specific amount of collateral cryptocurrency; and
storing, by the secure data conveyance device, the specific amount of collateral cryptocurrency in the secure stake pool.

5. The method of claim 1 further comprises:
when the first cryptocurrency is not a valid form of cryptocurrency:
rejecting, by the secure data conveyance device, the request.

6. The method of claim 1, wherein the validation protocol comprises:
determining, by the secure data conveyance device, one or more of:
whether a confirmation speed of the first cryptocurrency meets a performance threshold;
whether the first cryptocurrency is a recognized cryptocurrency format; and
whether the digital wallet rendered by the digital wallet application meets an integrity threshold.

7. The method of claim 1, wherein the known and trusted cryptocurrency of the system includes one or more of:
a system specific cryptocurrency; and
a cryptocurrency known and trusted by the secure and trusted data communication system.

8. The method of claim 1, wherein the obtaining the set of units of collateral cryptocurrency for the plurality of units for first cryptocurrency based on the established per unit value of the first cryptocurrency further comprises:
receiving, by the secure data conveyance device, the set of units of collateral cryptocurrency for the plurality of units from the computing device.

9. The method of claim 1, wherein the obtaining the set of units of collateral cryptocurrency for the plurality of units for first cryptocurrency based on the established per unit value of the first cryptocurrency further comprises:
obtaining, by the secure data conveyance device, the set of units of collateral cryptocurrency for the plurality of units from the computing device from another computing device of the secure and trusted data communication system.

10. A computer readable memory comprises:
a first memory element that stores operational instructions that, when executed by a secure data conveyance device of a secure and trusted data communication system, causes the secure data conveyance device to:
receive a request from a computing device regarding a digital wallet application executed by the computing device, wherein the request is requesting a digital wallet rendered by the digital wallet application to be recognized and accepted within the secure and trusted data communication system for purposes of financial transactions using a first cryptocurrency; and
a second memory element that stores operational instructions that, when executed by the secure data conveyance device, causes the secure data conveyance device to:
verify that the first cryptocurrency is a valid form of cryptocurrency in accordance with a validation protocol;
when the first cryptocurrency is a valid form of cryptocurrency:
establish a per unit value of the first cryptocurrency based on a per unit value of a known and trusted cryptocurrency of the system; and
obtain a set of units of collateral cryptocurrency for a plurality of units of first cryptocurrency based on the established per unit value of the first cryptocurrency, wherein the secure data conveyance device stores the set of units of collateral cryptocurrency in a secure stake pool for transactions utilizing the first cryptocurrency.

11. The computer readable memory of claim 10 further comprises:
a third memory element that stores operational instructions that, when executed by the secure data conveyance device, causes the secure data conveyance device to:
receive a conveyance request from a user computing device of the secure and trusted data communication system, wherein the user computing device includes a first cryptocurrency digital wallet rendered by the digital wallet application for storage of the first cryptocurrency, wherein the conveyance request requests that a specific amount of the first cryptocurrency be conveyed to a merchant computing entity of the secure and trusted data communication system;
when the conveyance request is authenticated:
obtain the specific amount of the first cryptocurrency from the first cryptocurrency digital wallet;
convert the specific amount of the first cryptocurrency into a specific amount of fiat currency;
send the specific amount of fiat currency to a trusted stored value account (SVA) device of the secure and trusted data communication system; and
a fourth memory element that stores operational instructions that, when executed by the trusted SVA device, causes the trusted SVA device to:
convert the specific amount of fiat currency into an SVA, wherein the SVA is only usable by the merchant computing entity;
send the SVA to the secure data conveyance device; and
a fifth memory element that stores operational instructions that, when executed by the secure data conveyance device, causes the secure data conveyance device to:
add an expiration time frame to the SVA;
forward the SVA with the expiration time frame to the user computing device; and
a sixth memory element that stores operational instructions that, when executed by the user computing device, causes the user computing device to:
conveying, via a direct communication link, the SVA with the expiration time frame to the merchant computing entity when data conveyance between the user computing device and the merchant computing entity is confirmed.

12. The computer readable memory of claim 11, wherein the third memory element further stores operational instructions that, when executed by the secure data conveyance device, causes the secure data conveyance device to obtain the specific amount of the first cryptocurrency from the first cryptocurrency digital wallet further by:
requesting the specific amount of the first cryptocurrency from the user computing device; and
when the specific amount of the first cryptocurrency is not received from the user computing device within a time period:
obtaining a specific amount of collateral cryptocurrency of the set of units of collateral cryptocurrency substantially equal to the specific amount of the first cryptocurrency in order to complete the conveyance request.

13. The computer readable memory of claim 12, wherein the third memory element further stores operational instructions that, when executed by the secure data conveyance device, causes the secure data conveyance device to:
when the specific amount of the first cryptocurrency is received from the user computing device after the time period:
convert the specific amount of the first cryptocurrency to the specific amount of collateral cryptocurrency; and
store the specific amount of collateral cryptocurrency in the secure stake pool.

14. The computer readable memory of claim 10, wherein the second memory element further stores operational instructions that, when executed by the secure data conveyance device, causes the secure data conveyance device to:
when the first cryptocurrency is not a valid form of cryptocurrency:
reject the request.

15. The computer readable memory of claim 10, wherein the validation protocol comprises:
determining, by the secure data conveyance device, one or more of:
whether a confirmation speed of the first cryptocurrency meets a performance threshold;
whether the first cryptocurrency is a recognized cryptocurrency format; and
whether the digital wallet rendered by the digital wallet application meets an integrity threshold.

16. The computer readable memory of claim 10, wherein the known and trusted cryptocurrency of the system includes one or more of:
a system specific cryptocurrency; and
a cryptocurrency known and trusted by the secure and trusted data communication system.

17. The computer readable memory of claim 10, wherein the second memory element further stores operational instructions that, when executed by the secure data conveyance device, causes the secure data conveyance device to obtain the set of units of collateral cryptocurrency for the plurality of units for first cryptocurrency based on the established per unit value of the first cryptocurrency by:
receiving the set of units of collateral cryptocurrency for the plurality of units from the computing device.

18. The computer readable memory of claim 10, wherein the second memory element further stores operational instructions that, when executed by the secure data conveyance device, causes the secure data conveyance device to obtain the set of units of collateral cryptocurrency for the plurality of units for first cryptocurrency based on the established per unit value of the first cryptocurrency by:
obtaining the set of units of collateral cryptocurrency for the plurality of units from the computing device from another computing device of the secure and trusted data communication system.
